(19) United States
(12) Patent Application Publication
(10) Pub. No.: US 2010/0059975 A1
(43) Pub. Date: Mar. 11, 2010

(54) Gas generator

(75) Inventors: Peter Sattler, Bockelwitz (DE); Joachim Hock, Grossostheim (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/385,975

(22) Filed: Apr. 24, 2009

Related U.S. Application Data
(63) Continuation of application No. PCT/EP2007/009314, filed on Oct. 26, 2007.

(30) Foreign Application Priority Data
Oct. 26, 2006 (DE) 10 2006 051 170.0

(51) Int. Cl. B60R 21/26; B23P 11/00; B23K 11/00

(52) U.S. Cl. 280/741; 29/428; 219/117.1; 219/700

(57) ABSTRACT

A method for producing a gas generator for installation in a motor vehicle airbag device includes providing a housing of the gas generator in a pressure chamber. The housing has an opening formed by an absence of a base of the housing and is filled with gas through the opening. The method includes providing a closure formed by the housing base in the pressure chamber. The closure is configured to provide gas-tight closure of the opening. The method includes fixing the housing in the pressure chamber transverse to a first direction, forming an annular gap between the closure and an edge of the housing by spacing the closure from the housing in the first direction using a first electrode, introducing gas into the pressure chamber and housing via the opening, and connecting the closure to the housing such that the closure covers the opening in a gas-tight closed state.

### CROSS-REFERENCE TO RELATED PATENT APPLICATIONS

This application is a Continuation of International Patent Application No. PCT/EP2007/009314, filed Oct. 26, 2007, which was published in German as WO 2008/049627 and is incorporated herein by reference in its entirety.

### BACKGROUND

The disclosure relates to a method for producing a gas generator for an airbag device for a motor vehicle, a device for producing a gas generator, and a gas generator produced by the method. Gas generators use gas to inflate a motor vehicle airbag stored in a housing of the gas generator and that is released upon ignition of the gas generator.

### SUMMARY

One embodiment of the disclosure relates to a method for producing a gas generator for installation in an airbag device for a motor vehicle. The method includes the step of providing a housing of the gas generator in a pressure chamber. The housing has an opening formed by an absence of a base of the housing. The housing is filled with gas through the opening. The method also includes the step of providing a closure formed by the housing base in the pressure chamber. The closure is configured to provide gas-tight closure of the opening. The method also includes the steps of fixing the housing in the pressure chamber transverse to a first direction, forming an annular gap between the closure and an edge of the housing by spacing the closure from the housing in the first direction using a first electrode, introducing gas into the pressure chamber so that gas enters the housing via the opening, and connecting the closure to the housing such that the closure covers the opening in a gas-tight manner in a closed state.

Another embodiment of the disclosure relates to a device for producing a gas generator for an airbag device for a motor vehicle. The device includes a pressure chamber configured for filling with gas and configured to receive a housing of the gas generator. The housing is filled with gas via an opening of the housing so that gas introduced into the pressure chamber can enter the housing through the opening. The device also includes an element displaceable in a first direction from a first position to a second position. The element is configured in the second position to press a closure of the gas generator arranged in the pressure chamber in the first direction against the housing filled with gas to close the opening. The element includes a first electrode configured to be electrically connected to the closure in the second position. The closure is formed by a base of the housing. The device also includes a second electrode arranged at least partially in the pressure chamber and configured for electrically connecting with the housing. The element is configured to press the closure against the housing when in the second position in such a manner that the closure outside the housing covers the opening formed by the absence of the base. The second electrode includes a body having a recess configured to receive an end portion of the housing. The body is located in the pressure chamber at a distance from the base. Alternatively, the second electrode is displaceably mounted on the pressure chamber.

Another embodiment of the disclosure relates to a gas generator for inflating an airbag with gas. The gas generator includes a housing, an opening of the housing configured to fill the housing with gas during production of the gas generator, and a closure for closing the opening to form a gas-tight accumulator with the housing of the gas generator to store the gas contained therein. The opening is formed by an absence of a base of the housing. The closure is configured as the housing base and covers the opening outside the housing.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic cross-sectional view of a device for producing a gas generator and a gas generator arranged in the device, according to an exemplary embodiment.

FIG. 2 is a schematic cross-sectional view of a modification of the device shown in FIG. 1, according to an exemplary embodiment.

### DETAILED DESCRIPTION

According to an exemplary embodiment, a method for producing a gas generator may be similar to a method described in DE 2457501, which is herein incorporated by reference in its entirety. At least a portion of a housing of the gas generator (which forms a receptacle that can be filled with gas via an opening) is first arranged in a pressure chamber. The method also provides a closure or closure part (e.g., a steel ball) for gas-tight closure of the opening in the pressure chamber. After gas is introduced into the pressure chamber and housing via the opening, the opening of the housing is closed in a gas-tight manner by the steel ball being pressed into the opening.

At least a part of the gas to be released is stored in a gaseous state in the gas generator. In particular, the gas generator may be a cold gas generator in which the total quantity of gas that can be released is stored in the gaseous state in a suitable container or a hybrid gas generator in which the gas is stored both in the gaseous state and in the form of a fuel that releases gases for inflating a gas bag upon combustion.

A disadvantage of conventional methods is that an opening is worked into the housing of the gas generator and—like a steel ball for pressing into the opening—has narrow tolerances to ensure a gas-tight seal of the opening. This step is generally complex and cost-intensive.

According to various other exemplary embodiments, a method for producing a gas generator and a device for carrying out the method provides simple and low-cost sealing of the opening. The method may provide various steps, for example providing a housing of the gas generator in a pressure chamber such that the pressure chamber surrounds at least a portion of the housing. The housing may be filled with gas via an opening arranged in the pressure chamber (e.g., the open covering surface of the housing). The opening of the housing may be an opening that is formed by an absence of a side of the housing.

The method may also provide a closure in the pressure chamber for gas-tight closure of the opening. The closure may be formed by a base of the housing. The method may also include introducing gas into the pressure chamber in such a manner that the gas enters the housing at least partially via the opening. The method may also provide a gas-tight closure of the housing the closure inside the pressure chamber such that the closure covers the opening when in a closed state.

Because the opening of the housing is closed or covered by a closure, a step of providing an opening of the housing adapted to a closure (e.g., in the form of a steel ball) can advantageously be omitted. Because the closure covers the opening, the closure may project beyond the outside of the opening. In order to cover the opening, the closure has a cross-sectional area (in a cross-sectional plane disposed parallel to the plane of the opening) that is larger than the cross-sectional area of the opening. The closure may not rest in a planar manner on an edge region bordering the opening.

According to an exemplary embodiment, the closure is preferably formed from a base of the housing. The housing is preferably a hollow cylinder open at one end. The closure is preferably a cylindrical base that is configured to cover the opening, for example an open end face of the cylindrical housing.

According to various exemplary embodiments, the method advantageously allows a complete work sequence prior to filling the housing with gas, for example forming a welded connection between the housing and the closure and the subsequent forming of the opening in the housing to be closed by the steel ball.

In general terms, an opening of the housing (e.g., an open covering surface) may be any opening formed by the absence or omission of a side of the housing. The side of the housing may be, for example, a base of the housing.

According to an exemplary embodiment of the method, the gas-tight closure of the opening (e.g., open covering surface) is connected to the housing by resistance welding. Both housing parts (housing and closure) may be accordingly configured to be electrically conductive.

Prior to the introduction of gas into the housing, the closure may preferably be positioned with respect to the opening such that a gap (e.g., an annular gap) is formed between the housing and the closure. Gas introduced into the pressure chamber can flow into the housing through the gap. Depending on the position of the closure, the size of the gap can be configured variably so that with a suitably large gap the filling times are advantageously short.

Once a predefined filling quantity of gas is reached in the housing during the introduction of gas into the pressure chamber, the closure may be pressed in a first direction against an edge of the housing bordering the opening (e.g., outside the opening).

The closure may be preferably pressed in the first direction against the edge of the housing by a first electrode so that a conductive connection between the closure and the housing is established. The two housing parts (housing and closure) may be configured to be electrically conductive.

According to another exemplary embodiment, the housing may be centered in the pressure chamber prior to formation of the annular gap through which the housing is filled with gas. The first electrode moves downwardly with the closure in the first direction and presses the closure into the opening of the housing. The housing is thereby aligned or centered with respect to the closure.

According to another exemplary embodiment, the closure may be centered in the opening in a plane disposed transverse to the first direction so that the housing can be fixed with respect to the pressure chamber and the closure can be pressed against the edge of the housing. The closure may be aligned in the opening transverse to the first direction. The closure preferably has a chamfer on an edge oriented towards the housing or the opening.

In order that the two housing parts can be connected to one another by resistance welding, the housing may be connected in the pressure chamber to a second electrode configured for resistance welding prior to the introduction of gas into the pressure chamber. The latter or second electrode may form a bracing element for the housing. Through the application of a pressure to the closure in the first direction by the first electrode, the closure is pressed against the housing and consequently the housing is pressed against the second electrode.

According to another exemplary embodiment, the housing may be fixed in the pressure chamber transverse to the first direction by a second electrode displaceably mounted on the pressure chamber. The housing may first be centered in the pressure chamber as described above and then the housing can be clamped by the second electrode so that it is fixed at least transverse to the first direction. The second electrode may press against the housing transverse to the first electrode or extend tightly around the housing in cross section. The closure may then be raised from the housing by the first electrode so that an annular gap is formed through which the housing can be filled with gas.

After filling, the closure may be pressed against the edge of the opening of the housing by the electrode and connected to the housing by resistance welding. To connect the two housing parts by resistance welding, a voltage is provided between the two electrodes such that a sufficient current (flowing via the edge) is generated between the housing and the closure. The current formats a gas-tight resistance-welded connection between the two housing parts. The gas is preferably introduced into the pressure chamber at a pressure greater than or equal to 600 bar.

According to various exemplary embodiments, a device for producing a gas generator may include a pressure chamber that may be filled with gas and that is configured to enclose a housing of the gas generator, which can be filled with gas through an opening, in a gas-tight manner. Gas introduced into the pressure chamber can enter the housing through the opening. The device may also include an element that is displaceable in a first direction from a first to a second position and that is configured to press in the second position a closure of the gas generator in the pressure chamber against the gas-filled housing in a first direction to close the opening. The displaceable element may be configured to press the closure, which is formed by a base of the housing, against the housing in the second position in such a manner that the closure covers the opening formed by the absence of the housing base outside of the opening.

The opening of the housing may be an open covering surface of the housing and the closure can form the covering surface. In order to cover the opening oriented in the first direction, the closure may have a cross-sectional area (in a cross-sectional plane disposed transversely to the first direction) that is larger than a largest cross-sectional area of the opening in a cross-sectional plane disposed transverse to the first direction.

The displaceable element may preferably be configured to press the closure against an edge bordering the opening (e.g., outside the opening) in the second position to generate or effect an electrically conductive connection between the two housing parts. The housing parts (housing and closure) are electrically conductive. The displaceable element is preferably configured as a first electrode connected in an electrically conductive manner (electrically connected) to the closure in the second position.

In order to connect the two housing parts by resistance welding, a second electrode arranged at least partially in the pressure chamber is configured to be electrically connected to the housing of the gas generator.

According to another exemplary embodiment, the second electrode has a body with a recess that is configured to receive an end portion of the housing of the gas generator. The receptacle may be dimensioned so the end portion of the housing is braced against the body when arranged in the receptacle. The body may extends in cross section around the end portion of the housing in such a manner that after being arranged in the receptacle of the body the housing of the gas generator is gripped firmly and immovably in the body.

In order to form an electrical connection to the body of the second electrode, the pressure chamber may include an electrically conductive base (e.g., made of copper) from which the body is spaced in the pressure chamber.

According to another preferred exemplary embodiment, the second electrode may be mounted longitudinally and displaceable on a wall of the pressure chamber. The second electrode preferably comprises at least a first slide element mounted to displace back and forth transverse to the first direction between a first and a second position in an opening of the pressure chamber, which is insulated and sealed with respect to the wall. The first slide element is preferably configured with a narrowed abutment end that is a distance (transversely to the first direction) from a lateral surface of the housing extending around the opening in the first position and that is pressed against the lateral surface transverse to the first direction in a second position so that an electrically conductive connection between the abutment end and the lateral surface is established. An advantage of this arrangement is that the lateral surface is located in proximity to the edge of the opening of the housing so that both electrodes can become operative directly in the region of the connection to be established between the closure and the housing.

The second electrode preferably has a further, second slide element that is mounted to displace back and forth between a first and a second position in a second opening of the pressure chamber transverse to the first direction. The two slide elements are preferably disposed opposite to one another so that they are moved towards one another upon being displaced from their respective first position to their respective second position. The housing can be clamped inside the pressure chamber between the abutment ends (oriented towards one another) of the two slide elements. The abutment ends are preferably configured so that they bear against the lateral surface of the housing in a form-fitting manner in the respective second position of the slide elements.

The two slide elements form a mechanical bracing arrangement for the housing (when located in the second position) that may prevent or reduce spreading of the housing during the resistance welding process.

The pressure chamber preferably has a wall spaced from the base that is made of a steel. The wall is connected to the base via an electrical insulator so that current cannot flow via the wall of the pressure chamber.

The pressure chamber preferably has an electrically insulating cover (e.g., made of Pertinax) that is disposed opposite the base of the pressure chamber in the first direction and is connected in a gas-tight manner to the wall of the pressure chamber. The cover of the pressure chamber preferably has a through-opening through which the displaceable element passes into the pressure chamber.

In order to seal this opening, an annular seal (e.g., made of PTFE) may be provided. The sealing ring is preferably arranged in a groove that runs around an inner face of the opening oriented towards the displaceable element so that the annular seal extends around and rests sealingly against the displaceable element in cross section. In the event that a second electrode comprising two slide elements is provided, the seals are preferably also used to seal the two openings in which the two slide elements are mounted in the wall of the pressure chamber.

According to various exemplary embodiments, a gas generator includes a housing with an opening that is configured to serve as a gas fill opening during production and a closure for the opening that forms a gas-tight accumulator with the housing of the gas generator for storing the gas to be used for inflating an airbag.

According to an exemplary embodiment, the opening may be formed by an open covering surface of the housing. An opening of the housing (e.g., an open covering surface) may be any opening that is formed by the absence of a side of the housing. The closure configured as the housing base (covering surface) can cover the opening outside the housing.

According to an exemplary embodiment, the gas generator may be constructed in a simple, low-cost manner and permit simple filling of the housing of the gas generator with gas and simple subsequent closure of the opening of the housing for filling.

The opening of the housing is preferably oriented in a first direction. A cross-sectional area of the closure in a cross-sectional plane oriented transverse to the first direction may be larger than a largest cross-sectional area of the opening in a cross-sectional plane oriented transverse to the first direction. In order to connect the two housing parts (housing and closure), the closure can advantageously be simply pressed against an edge of the housing bordering the opening.

The housing and the closure are preferably connected to one another by a welded connection that is preferably formed by a resistance welding process. The resistance welding process may be advantageously assisted by the arrangement of the two housing parts with respect to one another; the closure can cover the opening of the housing.

According to another exemplary embodiment, the closure has on an edge oriented towards the housing a chamfer that forms an abutment face for the housing. The chamfer may allow the closure to be centered with respect to the opening of the housing when the closure is pressed against the housing in connecting the two housing parts.

The opening of the housing may be an open covering surface of the housing. The closure may form the covering surface of the housing. Preferably, the closure may be formed by a base of the housing of the gas generator. The base of the housing may cover an opening of the housing in the form of an open covering surface. The housing preferably has a cylindrical configuration and the base of the housing extends beyond the opening (open end face of the cylindrical housing) transverse to the axis of the cylinder.

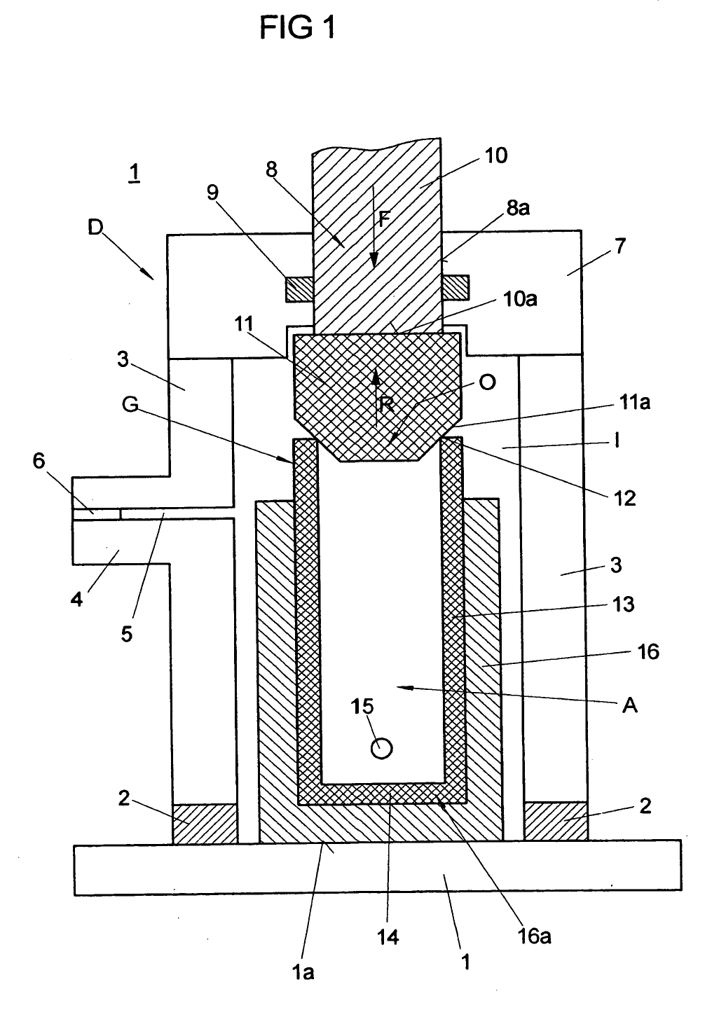

FIG. 1 shows a schematic side view of a device 1 for producing a gas generator G comprising a pressure chamber D that surrounds an interior I of the pressure chamber D according to an exemplary embodiment. Interior I the gas generator G is arranged for filling with gas.

The pressure chamber D has a planar base 1 that may be made of copper. A wall 3 of the pressure chamber D is spaced in a first direction R from an inner face 1a of the base 1 oriented towards the interior I. The wall 3 is connected to the base 1 via an electrical insulator 2 so that a current flow cannot occur between the base 1 and the wall 3.

In order to introduce gas into the interior I of the pressure chamber D, the wall 3 has a gas inlet 5 that is closable in a gas-tight manner by a valve 6. In order to connect a gas line to the gas inlet 5 or the valve 6, the valve 6 and the gas inlet 5 are formed on a suitably adapted projection 4 of the wall 3.

A cover 7 of the pressure chamber D is disposed opposite the base 1 in the first direction R and is fixed in a suitable manner to an end face of the wall 3 oriented towards the cover 7.

The gas generator G arranged in the interior I comprises a housing 13 that forms a receptacle A that can be filled with gas. The housing 13 is a half-open hollow cylinder with an opening O that is an open covering surface of the hollow cylinder oriented in the first direction R. The opening O is oriented towards the cover 7 of the pressure chamber D in the first direction R.

An end portion 14 of the housing 13 of the gas generator G located opposite the opening O (open end face of the housing 13) in the first direction R is inserted in the first direction R in a recess 16a of a body 16 made of copper so that the end portion 14 of the housing 13 at least partially or completely fills the recess of the body 16. The recess 16a of the body 16 is dimensioned so that the housing 13 of the gas generator G braces against the recess 16a of the body 16 after being inserted therein. The body 16 fixes the housing 13 in the interior I of the pressure chamber D and establishes an electrical connection between the base 1 and the housing 13. The body 16 is made of copper and is electrically connected to the base 1 via the inner face 1a of the base 1. The base 1 and the body 16 form an electrode (referred to as the second electrode) that is electrically insulated with respect to the steel wall 3 by the electrical insulator 2. Because the electrically conductive housing 13 is braced against the body 16 of the second electrode, an electrically conductive connection exists between the second electrode and the housing 13.

In order to close the opening O of the housing 13 after a filling of the housing 13 with gas, a closure 11 in the form of a cylindrical end piece (e.g., the base of the housing) is provided, which is configured to cover the opening O in the closed state. The closure 11 has a chamfer 11a on an edge oriented towards the housing 13 so that the cross section of the closure diminishes in (against) the first direction R. At least a portion of the closure 11 can be inserted into the receptacle A of the housing 13 through the opening O in the first direction R.

In order to fill the housing 13 with gas, the closure 11 is arranged with respect to the opening O so that an annular gap is formed between an edge 12 bordering the opening O, which surrounds the opening O in the form of a ring. A chamfer 11a forms an abutment face for this edge 12. Gas (introduced into the interior I of the pressure chamber D at approximately 600 bar through the gas inlet 5) enters the housing 13 of the gas generator G through the annular gap. After a predefined gas fill quantity has been reached in the housing 13, the gas supply is stopped and the abutment face 11a of the closure 11 is pressed against the edge 12 of the housing 13 in the first direction R. A longitudinally extending element 10 is displaceable in the first direction R and passes through a through-opening 8 of the cover 7 into the interior I of the pressure chamber D. The displaceable element 10 is configured to be displaceable between a first and a second position. The inner face 8a of the through-opening 8 is oriented towards the displaceable element 10 and is a bearing surface of the displaceable element 10.

The displaceable element 10 cooperates with the closure 11 in such a manner that the annular gap between the closure 11 and the housing 13 for filling the housing 13 is formed in the first position of the displaceable element 10. The displaceable element 10 presses the closure 11 in the first direction R with a force F against the edge 12 of the housing 13 in the second position of the displaceable element 10. The displaceable element 10 may be fixed to the closure 11 by an inner face 10a oriented towards the closure 11. However, such a rigid connection between the displaceable element 10 and the closure 11 is not essential. A peripheral groove is provided in the inner face 8a for sealing the through-opening 8 of the cover 7, includes a sealing ring 9 (e.g., made of PTFTE), and sealingly surrounds the displaceable element 10.

The displaceable element 10 is configured as a first electrode electrically connected to the electrically conductive closure 11 in the second position. In the second position, the displaceable element 10 presses against the closure 11 in the first direction R. When a voltage is applied between the first and second electrodes 10, 1, 16, a current can flow between the housing 13 and the closure 11 via the edge 12 and produces a gas-tight resistance-welded connection between the closure 11 and the housing 13.

In order to arrange the gas generator G in the interior I of the pressure chamber D or to remove it, the cover 7 may be, for example, detachably connected (in a gas-tight manner) to the wall 3 of the pressure chamber D. A sealing ring is preferably arranged in the first direction R between the end face of the wall 3 and the cover 7. The sealing ring may ensure or improve a gas-tight connection between the wall 3 and the cover 7 when the cover 7 is preloaded against the end face of the wall 3, for example by a screw connection.

A discharge opening 15 for discharging the gas of the gas generator G stored in the housing 13 can be opened, for example by an ignition device, and is provided in the housing 13 of the gas generator G so that the gas stored in the housing 13 of the gas generator G can be released.

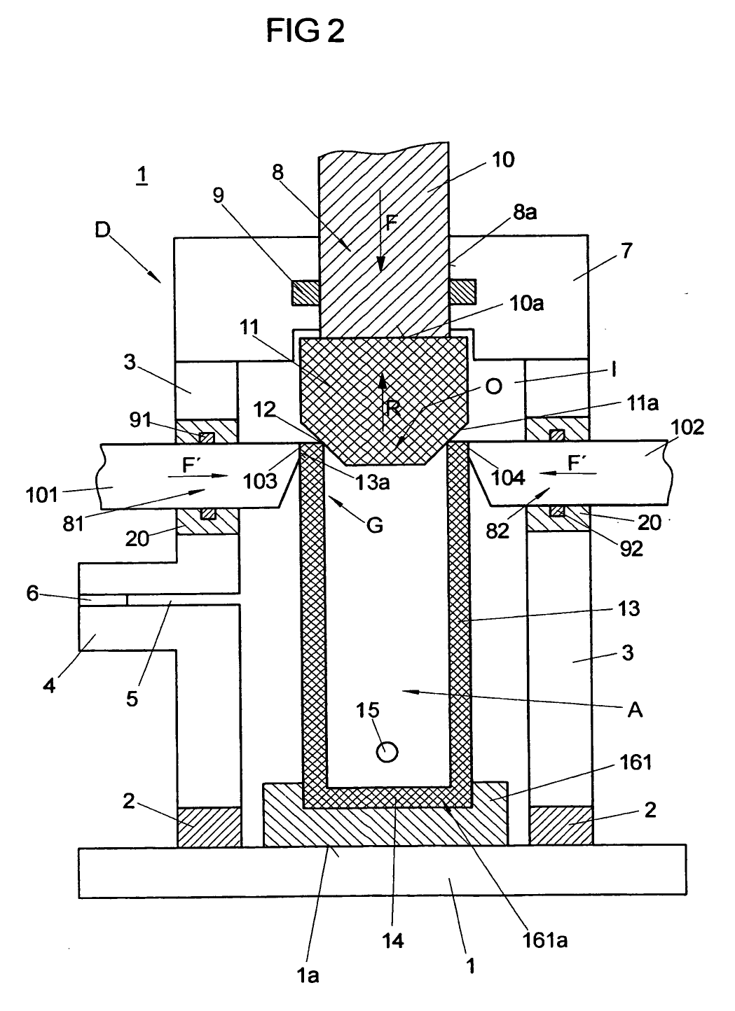

FIG. 2 shows a schematic sectional view of a device 1 according to another exemplary embodiment for producing a gas generator G in which, in contrast to the device shown in FIG. 1, a second electrode in the form of the body 16 is not provided, but a second electrode is formed by two slide elements 101, 102.

The two slide elements 101, 102 are mounted in the wall 3 of the pressure chamber D approximately level with the edge 12 of the housing 13 in the first direction R. The two slide elements 101, 102 are each arranged in a longitudinally displaceable manner in through-openings 81, 82 of the wall 3 on each side of the housing 13 so that they are movable, (towards one another) transversely with respect to the first direction R from a first position to a second position. Respective abutment ends 103, 104 of the two slide elements 101, 102 press with the force F′ firmly against a lateral surface 13a of the housing 13 surrounding the opening O of the housing 13 in the second position so that the housing 13 is clamped firmly between the slide elements 101, 102 and resulting in an electrically conductive connection between the slide elements 101, 102 and the lateral surface 13a.

A body 161 with a recess 161a in which the end portion 14 of the housing 13 can be arranged, is provided on the base 1 of the pressure chamber D to fix the housing 13 in the pressure chamber D. However, such a body 161 is not essential.

After the housing 13 has been filled with gas the closure 11 is pressed with the first electrode 10 (as shown in the exemplary embodiment of FIG. 1) against the edge 12, which is located in proximity to the lateral surface 13a. The distance between the edge 12 and the lateral surface 13a transverse to the first direction R corresponds to the material thickness of the housing 13. Because of this short distance, the two housing parts 11, 13 can be welded together efficiently by the two electrodes 10, 101, 102.

A voltage is applied between the two electrodes 10, 101, 102, that is, between the displaceable element 10 and the two slide elements 101, 102. The voltage generates a current flow that welds the two housing parts 11, 13 to one another via the shortest connection between the first and second electrodes 10, 101, 102. The shortest connection runs from the first electrode 10 via the closure 11, the edge 12, and the lateral surface 13a to the abutment ends 103, 104 of the two slide elements 101, 102.

During resistance welding, the slide elements 101, 102 conduct current and are therefore insulated with respect to the wall 3 by insulators 20 that extend around each of the slide elements 101, 102 in cross section. The two insulators 20 each have a groove in which a sealing ring 91, 92 surrounds the respective slide element 101, 102 and that serves to seal the respective opening 81, 82.

The filling of the housing 13 with gas may pass through the following individual steps: The housing 13 is first introduced into the pressure chamber D. The first electrode 10 moves downwardly in the first direction R and presses the closure 11 against the housing 13, so that the latter is centered. The two slide elements 101, 102 (horizontal electrode) clamp the housing 13 in the region of the opening O and the first electrode 10 moves upwards so that the closure 11 opens an annular gap between the edge 12 of the housing 13 and the closure 11. Housing 14 is filled through the annular gap. The first electrode 10 again moves downward in the first direction R and presses the closure with a force F against the edge 12 of the opening O of the housing 13. A welding current is generated to connect closure 11 and housing 13 by applying a voltage between the two electrodes 10, 101, 102. The current welds the two housing parts to one another. The pressure chamber D is then opened and the housing 13 is removed.

The priority application, German Patent Application No. 10 2006 051 170.0 filed Oct. 26, 2006, including the specification, drawings, claims and abstract, is incorporated herein by reference in its entirety.

Given the disclosure of the application, one versed in the art would appreciate that there may be other embodiments and modifications within the scope and spirit of the application. Accordingly, all modifications attainable by one versed in the art from the present disclosure within the scope and spirit of the present application are to be included as further embodiments of the present application.

What is claimed is:

1. A method for producing a gas generator for installation in an airbag device for a motor vehicle, comprising the steps of:
providing a housing of the gas generator in a pressure chamber, the housing comprising an opening formed by an absence of a base of the housing, the housing being filled with gas through the opening;
providing a closure formed by the housing base in the pressure chamber, the closure configured to provide gas-tight closure of the opening;
fixing the housing in the pressure chamber transverse to a first direction;
forming an annular gap between the closure and an edge of the housing by spacing the closure from the housing in the first direction using a first electrode;
introducing gas into the pressure chamber so that gas enters the housing via the opening; and
connecting the closure to the housing such that the closure covers the opening in a gas-tight closed state.

2. The method as claimed in claim 1, wherein the closure is connected to the housing by resistance welding.

3. The method as claimed in claim 1, wherein prior to the introduction of gas the closure is positioned with respect to the opening in such a manner that an annular gap is formed between the housing and the closure, gas capable of being introduced into the housing through the annular gap.

4. The method as claimed in claim 3, wherein prior to formation of the annular gap, the housing is centered with respect to the closure by pressing the closure in the first direction against an edge of the housing that is transverse to the first direction.

5. The method as claimed in claim 1, wherein after the housing is filled with gas, the closure is pressed in the first direction against an edge of the housing bordering the opening.

6. The method as claimed in claim 5, wherein the closure is positioned transverse to the first direction with respect to the opening as it is pressed in the first direction.

7. The method as claimed in claim 5, wherein the closure is pressed against the edge of the housing by a first electrode configured for resistance welding.

8. The method as claimed in claim 5, wherein the housing is fixed in the pressure chamber transverse to the first direction.

9. The method as claimed in claim 8, wherein the housing is fixed by a second electrode configured for resistance welding.

10. The method as claimed in claim 9, wherein the housing is introduced into a recess of the second electrode to fix the housing.

11. The method as claimed in claim 9, wherein the housing is fixed transverse to the first direction by the second electrode, which is movably mounted on the pressure chamber.

12. The method as claimed in claim 9, wherein an electrically conductive connection is established between the second electrode and the housing.

13. The method as claimed in claim 12, wherein a voltage is provided between the first and second electrodes to connect the housing to the closure by resistance welding, the connection generating a current flow between the housing and the closure via the edge of the housing.

14. The method as claimed in claim 7, wherein after the housing is filled with gas the closure is pressed by the first electrode against the edge of the housing in such a manner that an electrically conductive connection is established between the housing and the closure.

15. The method as claimed in claim 1, wherein as gas is introduced to the pressure chamber, the gas pressure in the pressure chamber is substantially greater than the pressure of the atmosphere surrounding the pressure chamber and is greater than or equal to 600 bar.

16. A device for producing a gas generator for an airbag device for a motor vehicle, comprising:
a pressure chamber configured for filling with gas and configured to receive a housing of the gas generator, the housing being filled with gas via an opening of the housing so that gas introduced into the pressure chamber can enter the housing through the opening;
an element displaceable in a first direction from a first position to a second position, the element configured in the second position to press a closure of the gas generator arranged in the pressure chamber in the first direction against the housing filled with gas to close the opening, the element comprising a first electrode configured to be electrically connected to the closure in the second position, the closure being formed by a base of the housing.
a second electrode arranged at least partially in the pressure chamber and configured for electrically connecting with the housing,
wherein the element is configured to press the closure against the housing when in the second position in such a manner that the closure outside the housing covers the opening formed by the absence of the base, and
wherein the second electrode comprises a body having a recess configured to receive an end portion of the housing, the body located in the pressure chamber at a distance from the base, or wherein the second electrode is displaceably mounted on the pressure chamber.

17. The device as claimed in claim 16, wherein the element is configured to press the closure against an edge of the housing bordering an outside of the opening when in the second position, portions of the housing being electrically conductive to generate an electrical connection between the housing and the closure.

18. The device as claimed in claim 16, wherein the pressure chamber comprises an electrically conductive base made of copper.

19. The device as claimed in claim 16, wherein the second electrode comprises at least one first slide element configured to displace back and forth transverse to the first direction in an opening of the pressure chamber between a first and a second position, the at least one first slide element configured in the first position so an abutment end of the slide element is spaced from a lateral surface of the housing that surrounds the opening transverse to the first direction, the at least one slide element configured in the second position so the abutment end is pressed against the lateral surface transverse to the first direction so that an electrically conductive connection between the abutment end and the lateral surface is established.

20. The device as claimed in claim 19, wherein the second electrode comprises a second slide element configured to displace back and forth transverse to the first direction between a first and a second position in a second opening of the pressure chamber.

21. The device as claimed in claim 20, wherein the second slide element is located opposite the first slide element transverse to the first direction.

22. The device as claimed in claim 20, wherein the first and second slide elements are configured to press against the housing in their respective second positions in such a manner that the housing is clamped between the first and second slide elements transversely to the first direction.

23. The device as claimed in claim 18, wherein the pressure chamber comprises a wall of a steel that is connected to the base via an electrical insulator.

24. The device as claimed in claim 18, wherein the pressure chamber comprises an electrically insulating cover of Pertinax that is located opposite the base in the first direction.

25. The device as claimed in claim 16, wherein the element passes into the pressure chamber via a through-opening of the pressure chamber.

26. The device as claimed in claim 25, wherein the through-opening is sealed by an annular seal of PTFE.

27. The device as claimed in claim 25, wherein the opening comprises an inner face oriented towards the displaceable element with a groove running around the opening and in which the annular seal is arranged.

28. A gas generator for inflating an airbag with gas, comprising:
a housing;
an opening of the housing configured to fill the housing with gas during production of the gas generator; and
a closure for closing the opening to form a gas-tight accumulator with the housing of the gas generator to store the gas contained therein,
wherein the opening is formed by an absence of a base of the housing, and wherein the closure is configured as the housing base and covers the opening outside the housing.

29. The gas generator as claimed in claim 28, wherein the opening is oriented in a first direction, a cross-sectional area of the closure in a cross-sectional plane being disposed transverse to the first direction being larger than a largest cross-sectional area of the opening in a cross-sectional plane disposed transverse to the first direction.

30. The gas generator as claimed in claim 28, wherein the housing and the closure are connected to one another by a resistance-welded connection.

31. The gas generator as claimed in claim 28, wherein the closure comprises a chamfer on an edge oriented towards the housing.

32. The gas generator as claimed in claim 31, wherein the chamfer forms an abutment face for the housing.
